(19) United States
(12) Patent Application Publication
(10) Pub. No.: US 2026/0067526 A1
(43) Pub. Date: Mar. 5, 2026

(54) METHOD AND APPARATUS FOR PROCESSING VIDEO TEMPLATE, DEVICE, READABLE STORAGE MEDIUM AND PRODUCT

(71) Applicant: Beijing Zitiao Network Technology Co., Ltd., Beijing (CN)

(72) Inventors: Yue LI, Beijing (CN); Dan LIU, Beijing (CN); Jingpeng GUO, Beijing (CN); Xiaolong YUE, Beijing (CN)

(21) Appl. No.: 19/310,648

(22) Filed: Aug. 26, 2025

(30) Foreign Application Priority Data
Aug. 27, 2024 (CN) 202411186651.4

(51) Int. Cl. H04N 21/431; H04N 21/44

(52) U.S. Cl. CPC H04N 21/4318; H04N 21/44008

(57) ABSTRACT

Embodiments of the present disclosure provide a method and apparatus for video template processing, a device, a computer-readable storage medium and a product. The method comprises: obtaining at least one editing element for generating a video template; generating, based on the editing element, a video editing model through a preset template editing protocol, wherein the template editing protocol includes a plurality of material types and declaration information corresponding to effect elements; serializing the video editing model based on the template editing protocol to obtain a serialized target video template; publishing the target video template in a preset application.

### CROSS-REFERENCE TO RELATED APPLICATION(S)

This application claims priority to Chinese Application No. 202411186651.4 filed Aug. 27, 2024, the disclosure of which is incorporated herein by reference in its entirety.

### FIELD

Embodiments of the present disclosure relate to the field of video processing technology, and more specifically, to a method and apparatus for video template processing, a device, a readable storage medium and a product.

### BACKGROUND

With improvements in hardware performance of terminal devices, an increasing number of applications (APP for short) are running on the terminal devices. A first user may generate and publish a video on a preset application deployed in a terminal device based on the material content and the preset video template.

To make the video template more in line with the individualized needs of users, the first user also may custom build a video template in a target application pre-deployed on the terminal device and publish the generated video template to the preset application for subsequent use. However, the protocol design of the current video template in general only supports insertion of video materials. That is, only a single type of material is supported and the target video generated based on the video template is therefore of poor quality.

### SUMMARY

Embodiments of the present disclosure provide a method and apparatus for video template processing, a device, a computer-readable storage medium and a product.

In accordance with a first aspect, embodiments of the present disclosure provide a method for video template processing, comprising:
obtaining at least one editing element for generating a video template, wherein the editing element includes slot information and audio content corresponding to a timeline associated with the video template, and at least one effect element; and the slot information includes a time range and material parameters corresponding to each preset slot, the material parameters comprising at least one material type and a material feature;
generating, based on the editing element, a video editing model through a preset template editing protocol, wherein the template editing protocol includes a plurality of material types and declaration information corresponding to effect elements;
serializing the video editing model based on the template editing protocol to obtain a serialized target video template;
publishing the target video template in a preset application.

In accordance with a second aspect, embodiments of the present disclosure provide a method for video template processing, comprising:
obtaining at least one material content determined by a second user, the material content including a target video and/or an image content;
determining in a plurality of preset templates a target video template matching with the at least one material content, the target video template being generated based on the method for video template processing according to the first aspect;
deserializing the target video template through a preset template editing protocol to obtain a video editing model matching with the target video template;
performing a video generating operation based on the video editing model and the at least one material content.

In accordance with a third aspect, embodiments of the present disclosure provide an apparatus for video template processing, comprising:
an obtaining module configured to obtain at least one editing element for generating a video template, wherein the editing element includes slot information and audio content corresponding to a timeline associated with the video template, and at least one effect element; and the slot information includes a time range and material parameters corresponding to each preset slot, the material parameters comprising at least one material type and a material feature;
a generation module configured to generate, based on the editing element, a video editing model through a preset template editing protocol, wherein the template editing protocol includes a plurality of material types and declaration information corresponding to effect elements;
a serializing module configured to serialize the video editing model based on the template editing protocol to obtain a serialized target video template;
a publishing module configured to publish the target video template in a preset application.

In accordance with a fourth aspect, embodiments of the present disclosure provide an apparatus for video template processing, comprising:
a communication module configured to obtain at least one material content determined by a second user, the material content including a target video and/or an image content;
a determination module configured to determine in a plurality of preset templates a target video template matching with the at least one material content, the target video template being generated by the apparatus for video template processing according to the third aspect;
a deserializing module configured to deserialize the target video template through a preset template editing protocol to obtain a video editing model matching with the target video template;
a processing module configured to perform a video generating operation based on the video editing model and the at least one material content.

In accordance with a fifth aspect, embodiments of the present disclosure provide an electronic device, comprising: a processor and a memory;
wherein the memory is stored with computer-executable instructions;
the processor executes computer-executable instructions stored in the memory, such that the at least one processor performs the method for video template processing according to the first aspect and various possible designs of the first aspect or the second aspect and various possible designs of the second aspect.

In accordance with a sixth aspect, embodiments of the present disclosure provide a computer-readable storage medium stored with computer-executable instructions, wherein the computer-executable instructions, when executed by a processor, implement the method for video template processing according to the first aspect and various possible designs of the first aspect or the second aspect and various possible designs of the second aspect.

In accordance with a seventh aspect, embodiments of the present disclosure provide a computer program product, comprising computer programs, wherein the computer programs, when executed by a processor, fulfill the method for video template processing according to the first aspect and various possible designs of the first aspect or the second aspect and various possible designs of the second aspect.

### BRIEF DESCRIPTION OF THE DRAWINGS

Brief introduction of the drawings required in the following description of the embodiments or the prior art are to be introduced simply below to more clearly explain the technical solutions according to the embodiments of the present disclosure or in the related art. It is obvious that the following drawings only illustrate some embodiments of the present disclosure and those skilled in the art also may obtain other drawings on the basis those illustrated ones without any exercises of inventive work.

FIG. 1 illustrates a system architecture diagram on which embodiments of the present disclosure are based;

FIG. 2 illustrates a schematic flowchart of the method for video template processing provided by an embodiment of the present disclosure;

FIG. 3 illustrates a schematic flowchart of the method for video template processing provided by another embodiment of the present disclosure;

FIG. 4 illustrates a schematic diagram of an application scenario provided by an embodiment of the present disclosure;

FIG. 5 illustrates a schematic flowchart of the method for video template processing provided by an embodiment of the present disclosure;

FIG. 6 illustrates a schematic flowchart of the method for video template processing provided by a further embodiment of the present disclosure;

FIG. 7 illustrates a schematic diagram of another application scenario provided by an embodiment of the present disclosure;

FIG. 8 illustrates a structural diagram of the apparatus for video template processing provided by an embodiment of the present disclosure;

FIG. 9 illustrates a structural diagram of the apparatus for video template processing provided by an embodiment of the present disclosure;

FIG. 10 illustrates a structural diagram of an electronic device provided by embodiments of the present disclosure.

### DETAILED DESCRIPTION OF EMBODIMENTS

For a clearer picture of the objectives, technical solutions and advantages of the embodiments of the present disclosure, the technical solutions in the embodiments of the present disclosure are to be described clearly and completely with reference to the drawings in the embodiments of the present disclosure. It is obvious that the described embodiments are only part of the embodiments of the present disclosure, rather than all of them. All other embodiments obtained by those skilled in the art on the basis of the illustrated embodiments of the present disclosure without any exercises of inventive work fall within the protection scope of the present disclosure.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

To address the technical problem that the existing video templates support a single type of materials, the present disclosure provides a method and apparatus for video template processing, a device, a readable storage medium and a product.

It is to be explained that a method and apparatus for video template processing, a device, a readable storage medium and a product provided by the present disclosure may be applied to any scenarios for generating and publishing video templates.

Generic template is a general term for a video template with pre-made effects. Users may select video materials and use preset effects in the generic template, including effects, background music, transition effects, audio effects, and text styles among other contents, to quickly produce a video with exquisite effects. However, the current generic template in general only supports video materials. Therefore, the video effects made based on the generic template are monotonous.

In finding a solution to the above technical problem, the inventor has discovered through research that declarations of various types of materials may be added into a protocol for creating the generic template. For example, declarations of videos, pictures and effects among other contents may be added into the protocol. Accordingly, video templates supporting various contents, e.g., videos, pictures and effects etc., can be created. Moreover, a first user can generate a target video with better quality based on the video template.

In one possible implementation, after generating a video template in a target application, a first user may publish the video template into a preset application, such that a second user in the preset application may call the video template to perform a video generation operation. However, since the target application and the preset application usually use different template editing protocols, it is also required to perform a protocol conversion operation on the video template based on the video editing protocol of the preset application before the video template is published to the preset application. The operations are often complicated.

Alternatively, in order to quickly perform an operation of publishing the video template, the target application is made to use the same template editing protocol as the preset application. Accordingly, after generating the video editing template in the target application, the first user may serialize the video editing model based on the template editing protocol to obtain a serialized target video template. Besides, in response to a triggering operation by the first user, the target video template is published to the preset application. As such, the second user of the preset application, after obtaining the target video template, may de-serialize the target video template based on the template editing protocol, to obtain the video editing model. Moreover, an operation of selecting material contents may be performed, and the target video is generated based on the various types of material contents selected and the video editing model.

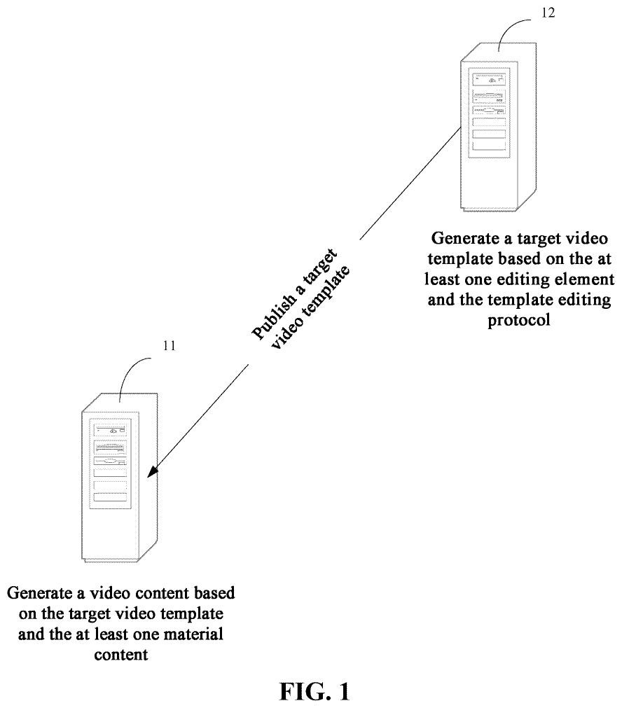

FIG. 1 illustrates a system architecture diagram on which embodiments of the present disclosure are based. As shown in FIG. 1, system architecture on which embodiments of the present disclosure are based at least includes: a server 11 corresponding to a target application and a server 12 corresponding to a preset application, wherein the server 11 is in communication with the server 12.

On the basis of the above system architecture, the server 11 can generate a template editing model based on at least one editing element selected by the first user in the target application and a preset template editing protocol, serialize the video editing model according to the template editing protocol and publish the serialized target video template. Correspondingly, the server 12 may recommend the target video template to the second user based on the material contents selected by the second user. The target video template is de-serialized according to the template editing protocol, and the target video is generated using the material contents selected by the second user based on the de-serialized video editing template.

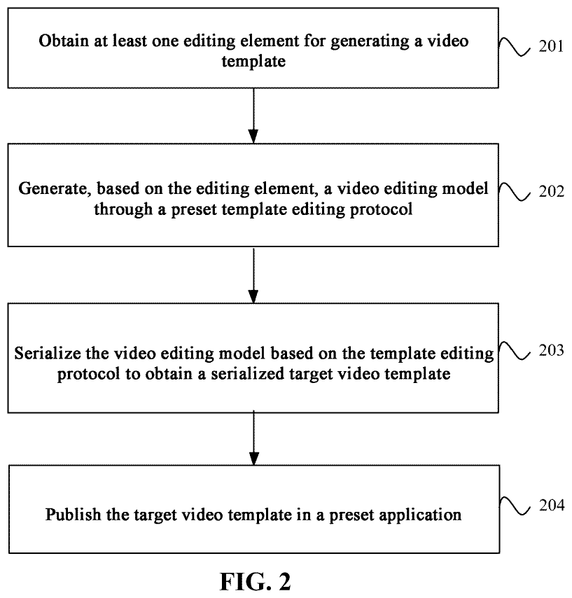

FIG. 2 illustrates a schematic flowchart of the method for video template processing provided by an embodiment of the present disclosure. According to FIG. 2, the method comprises:

Step 201: at least one editing element for generating a video template is obtained, wherein the editing element includes slot information and audio content corresponding to a timeline associated with the video template, and at least one effect element; and the slot information includes a time range and material parameters corresponding to each preset slot, the material parameters comprising at least one material type and a material feature.

The executive body of this embodiment is the apparatus for video template processing coupled into the target application. The first user may determine at least one editing element in the target application, such that the apparatus for video template processing may generate a target video template based on the at least one editing element and the preset template editing protocol, and publish the target video template into a preset application.

In this implementation, slot information and audio content corresponding to a timeline associated with the video template, and at least one effect element determined by the first user in the target application may be obtained, wherein the slot information includes a time range and material parameters corresponding to each preset slot. For example, the slot information may include a duration of a material, a type of a material and a characteristic of a material to be added into each slot. The material parameters include at least one material type and a material feature. The audio content may be background music and audio effects of the video template. The effect element includes, but not limited to, makeup effect, accessory effect, filter effect, AI effect, sticker, graffiti and the like.

Step 202: a video editing model is generated based on the editing element through a preset template editing protocol, wherein the template editing protocol includes a plurality of material types and declaration information corresponding to effect elements.

In this implementation, in order to generate the video template supporting various types of materials, a template editing protocol is preconfigured, wherein the template editing protocol includes a plurality of material types and declaration information corresponding to effect elements. Accordingly, the video editing model can be generated through a preset template editing protocol based on the editing element, and the video editing model can support addition of various types of materials.

Step 203: the video editing model is serialized based on the template editing protocol to obtain a serialized target video template.

In this implementation, the first user also may publish the video editing template generated in the target application into the preset application. The preset application may use the same template editing protocol as the target application.

Alternatively, the video editing model may be serialized based on the template editing protocol to obtain a serialized target video template.

Step 204: the target video template is published in a preset application.

In this implementation, the target video template may be published in a preset application. Therefore, the second user may determine at least one material content in the preset application, determine a matching target video template based on the at least one material content, and de-serialize the target video template based on the template editing protocol, to obtain the video editing model. The video may then be generated according to the video editing model and the material contents matching with the video editing model.

The method for video template processing provided by this embodiment adds various material types and declaration information corresponding to effect elements into the template editing protocol, so as to generate a video editing model supporting various material types based on at least one editing element determined by the first user. Moreover, the method serializes the video editing model based on the template editing protocol, so as to publish the serialized target video template in the preset application. After obtaining the target video template, the second user of the preset application de-serializes the target video template through the template editing protocol, to obtain a video editing model. The target video template in different applications is generated and published through the template editing protocol. In addition, a target video of better quality may be generated based on the diversified material contents determined by the second user and the video editing model to improve the content quality of the target video.

Alternatively, based on any of the above embodiments, the step 201 includes:
obtaining at least one editing element determined by the first user in the target application.

The method further comprises:
editing the editing element based on a preset first software development kit, to generate a data packet to be edited;
rendering the data packet to be edited to obtain a rendering effect;
presenting the rendering effect in the target application, to allow the first user to adjust the at least one editing element based on the rendering effect.

In this embodiment, the target application may provide the first user with a variety of different editing element for selection. As such, the first user may determine at least one editing element in the target application.

To bring the effects of the target video template closer to the individualized needs of the first user, after the editing element is edited based on a preset first software development kit to generate a data packet to be edited, the data packet to be edited may be rendered to gain a rendering effect, wherein the data packet to be edited may be rendered according to any rendering methods. The present disclosure is not restricted in this regard.

Furthermore, the rendering effect may be displayed in the target application, such that the first user may adjust the currently selected at least one editing element based on the rendering effect. Subsequently, the video template may be generated on the basis of the adjusted at least one editing element.

The method for video template processing provided by this embodiment generates a data packet to be edited based on the at least one editing element determined by the first user, then renders the data packet to be edited and displays the rendering effect in the target application, such that the first user can further adjust the data packet to be edited based on the rendering effect. Therefore, the finally generated target video template is more in line with the individualized needs of the first user and the user experience is enhanced.

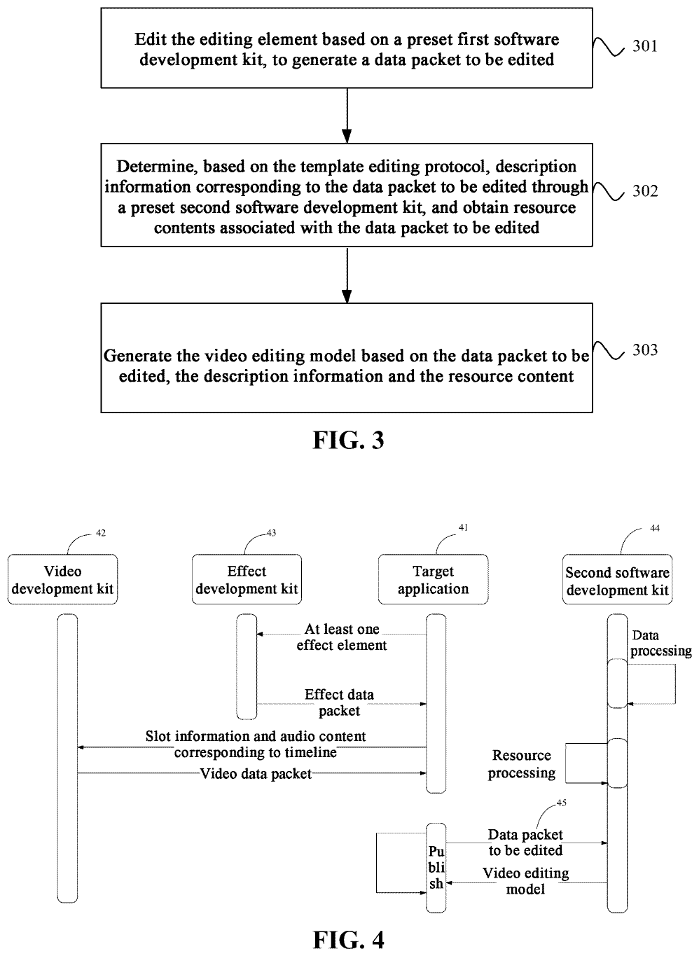

FIG. 3 illustrates a schematic flowchart of the method for video template processing provided by another embodiment of the present disclosure. Based on any of the above embodiments, as shown in FIG. 3, the step 202 includes:
Step 301: the editing element is edited based on a preset first software development kit, to generate a data packet to be edited;
Step 302: description information corresponding to the data packet to be edited is determined based on the template editing protocol through a preset second software development kit, and obtaining resource contents associated with the data packet to be edited, wherein the resource contents include one or more of effect resources, music resources, material resources and resource addresses;
Step 303: the video editing model is generated based on the data packet to be edited, description information and the resource content.

In this embodiment, to process the data of the editing element, the target application may establish communication connections with the first software development kit and the second software development kit in advance, and edit the editing element through the first software development kit and the second software development kit, to generate the data packet to be edited.

Alternatively, after the at least one editing element determined by the first user is obtained, the editing element is edited based on a preset first software development kit to generate a data packet to be edited.

Furthermore, after the data packet to be edited is generated, the data packet to be edited may be subject to data processing through the template editing protocol, so as to determine the description information corresponding to data packet to be edited. Besides, with respect to the music in the data packet to be edited, the video in the fixed slot and the image among other contents, resource contents associated with the data packet to be edited also may be obtained, wherein the resource contents include one or more of effect resources, music resources, material resources and resource addresses. The video editing model is generated based on the data packet to be edited, description information and the resource content.

The method for video template processing provided by this embodiment preconfigures a first software development kit and a second software development kit, so as to quickly and accurately process the editing element based on the first software development kit and the second software development kit. Besides, the method can add description information and resource contents into the video editing model, to enhance the generation efficiency and the accuracy of the video template.

Moreover, based on any of the above embodiments, the first software development kit includes a video development kit and an effect development kit. The step 301 includes:
editing the at least one effect element based on the effect development kit, to generate an effect data packet;
editing, based on the video development kit, slot information and audio content corresponding to a timeline associated with the video template, to generate a video data packet;
generating the data packet to be edited according to the effect data packet and the video data packet.

In this embodiment, the first software development kit includes a video development kit and an effect development kit. The editing element associated with the video among the editing elements may be edited based on the video development kit, and the editing element associated with the effects among the editing elements may be edited based on the effect development kit, to obtain the data packet to be edited.

Alternatively, as the editing element determined by the first user may include effect element and video-related editing element. The at least one effect element may be edited based on the effect development kit, to generate an effect data packet. For example, the effect development kit may add various animation effects, such as 3D, interchange, scaling, wipe, dissolve and picture in picture etc., into the video template based on the effect element. Slot information and audio content corresponding to a timeline associated with the video template are edited based on the video development kit, to generate a video data packet. The data packet to be edited is generated according to the effect data packet and the video data packet.

The method for video template processing provided by this embodiment preconfigures a video development kit and an effect development kit, so as to edit the editing element associated with the video among the editing elements based on the video development kit and edit the editing element associated with the effects among the editing elements based on the effect development kit, thereby obtaining the data packet to be edited.

Subsequently, the video editing model can be accurately obtained based on the at least one editing element determined by the first user, so as to gain a target video template compatible with various types of materials.

Moreover, based on any of the above embodiments, the step 302 includes:
for each resource content in the data packet to be edited, obtaining the resource content from a storage path associated with the resource content;
if the storage path does not include the resource content, determining a resource address associated with the resource content.

In this embodiment, the data packet to be edited may include background music and fixed slot etc., all of which correspond to resource contents. Accordingly, for each resource content in the data packet to be edited, the resource content is obtained from a storage path associated with the resource content. For example, the background music resources may be obtained from the storage path associated with the resource content.

If the storage path does not include the resource content, a resource address associated with the resource content may be determined. When the target video is generated subsequently based on the target video template, the resource content may be obtained from the resource address to generate the video.

FIG. 4 illustrates a schematic diagram of an application scenario provided by an embodiment of the present disclosure. As shown in FIG. 4, the target application 41 may be communicatively linked to the video development kit 42, the effect development kit 43 and the second software development kit 44 respectively. Accordingly, in response to selecting at least one editing content on the target application 41 by a user, the at least one editing element may be edited based on the effect development kit 43, to generate the effect data packet. The slot information and audio content corresponding to a timeline associated with the video template are edited based on the video development kit 42, to generate a video data packet. The data packet to be edited 45 is generated according to the effect data packet and the video data packet. The description information corresponding to the data packet to be edited 45 is determined through a preset second software development kit 44 based on the template editing protocol, and resource contents associated with the data packet to be edited are obtained. The video editing model is generated based on the data packet to be edited, description information and the resource content.

The method for video template processing provided by this embodiment adds resource contents or resource addresses into the data packet to be edited, such that the second user can generate a video based on the resource contents or the resource addresses, to promote the content quality of the generated target video.

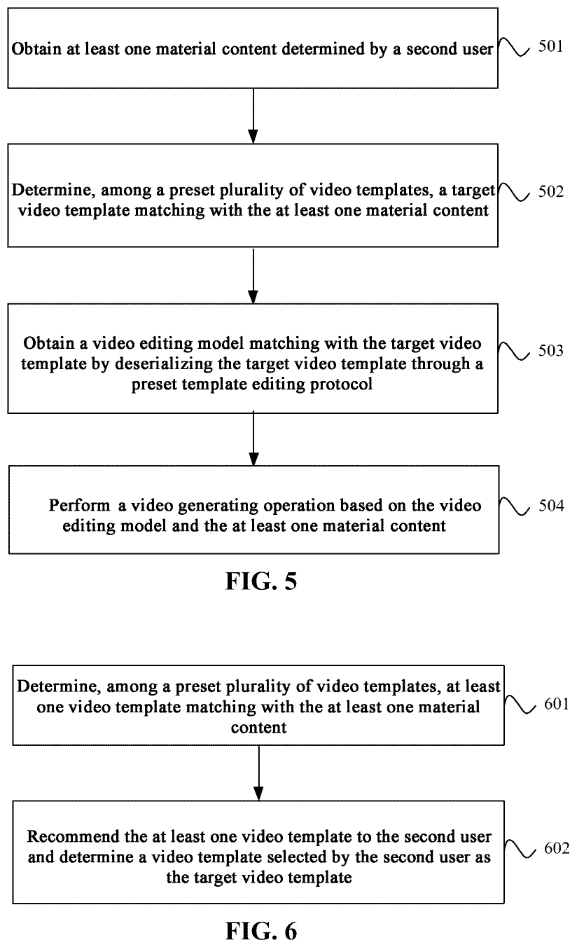

FIG. 5 illustrates a schematic flowchart of the method for video template processing provided by an embodiment of the present disclosure. As shown in FIG. 5, the method comprises:
Step 501: at least one material content determined by a second user is obtained, the material content including a target video and/or an image content;
Step 502: a target video template matching with the at least one material content is determined among a preset plurality of video templates, the target video template being generated based on the method for video template processing according to any of the above embodiments;
Step 503: the target video template is deserialized through a preset template editing protocol to obtain a video editing model matching with the target video template;
Step 504: a video generating operation is performed based on the video editing model and the at least one material content.

The executive body of this embodiment is the apparatus for video template processing coupled into the preset application. The second user may generate a video in the preset application based on the target video template and the at least one material content.

In this embodiment, the second user may determine at least one material content in the preset application, the material content including target video and/or image content, wherein the material content may be collected in real time by the second user and also may be uploaded by the second user in the preset storage path. The present disclosure is not restricted in this regard.

Furthermore, to increase the matching degree between the material content and the video template, after the at least one material content determined by the second user is obtained, a target video template matching with the at least one material content may be determined among a preset plurality of video templates according to the at least one material content determined by the second user, the target video template being generated based on the method for video template processing according to any of the above embodiments. The template editing protocol corresponding to the target video template includes declarations of various types of materials, which for example may include declarations of video materials, image materials and effect materials. Accordingly, the target video template may support material contents of different types.

Alternatively, since the target video template is published after being serialized by the target application based on the preset template editing protocol, in order to generate the target video based on the target video template, the target video template, after being obtained, may be de-serialized based on the template editing protocol to obtain the video editing model matching with the target video template. Further, the video may be generated based on the video editing model and the at least one material content.

As an implementable approach, the preset application may present a plurality of preset video templates for the second user to choose. In response to a selection operation triggered by the second user, the description information corresponding to the target video template selected by the second user may be determined, and the material parameters corresponding to the target video template are determined according to the description information. The user is prompted to select a material based on the material parameters. For example, the prompt information may be presented in the preset application, to indicate the second user to select a material of image type/video type, or indicate the second user to select a material content of landscape/character. After selecting the video template, the second user also may de-serialize the target video template based on the template editing protocol to obtain the video editing model. The target video is generated based on the video editing model and the material content determined by the user.

Alternatively, based on any of the above embodiments, the step 504 includes:
for each material content, determining a target slot matching with the material content in the video editing model;
adding the material content to the target slot to generate a target video.

In this embodiment, after the at least one material content and the target video template matching with the at least one material content are respectively determined, as the target video template includes at least one slot, the material content may be added into the at least one slot, to obtain the target video.

Alternatively, for each material content, a target slot matching with the material content may be determined in the video editing model. As the video editing model includes the description information, the description information at least includes slot information corresponding to each slot. As such, the target slot matching with the material content may be determined based on the material parameter corresponding to the material content and the slot information corresponding to each slot, and the material content is added into the target slot to generate the target video.

For example, the material content may be a 3-second video material including characters. It may be determined based on the description information that a 3-second character video material is to be added into the second slot in the video editing model. Accordingly, the material content may be added into the second slot. After each material content is added into the video editing model, target video is obtained.

The method for video template processing provided by this embodiment obtains at least one material content determined by the second user and then recommends the video template matching with the at least one material content to the second user. The target video template selected by the second user is de-serialized based on the template editing protocol, to obtain the video editing model matching with the target video template.

The video is generated based on the video editing model and the at least one material content, so as to generate the target video based on the diversified material contents and boost the content quality of the target video.

FIG. 6 illustrates a schematic flowchart of the method for video template processing provided by a further embodiment of the present disclosure. Based on any of the above embodiments, as shown in FIG. 6, the step 502 includes:

Step 601: at least one video template matching with the at least one material content is determined among a preset plurality of video templates;

Step 602: the at least one video template is recommended to the second user and a video template selected by the second user is determined as the target video template.

In this embodiment, to increase the matching degree between the material content and the video template, after the at least one material content determined by the second user is obtained, at least one video template matching with the at least one material content may be determined among a preset plurality of video templates, wherein the at least one video template matching with the at least one material content may be determined according to the material parameters corresponding to the material content and the slot information corresponding to various video templates.

Furthermore, to make the target video template for generating the target video more conform to the individualized needs of the second user, after the at least one video template matching with the at least one material content is determined, the at least one video template may be recommended to the second user. The second user may select the video template according to the actual needs. The video template selected by the second user may be determined as the target video template.

For example, after the second user determines at least one material content, at least one video template matching with the at least one material content may be presented in the preset application; and the second user may select the target video template via a preset operation of triggering the video template, wherein the preset triggering operation includes, but not limited to, single click, double click, long press and drag and drop etc.

The method for video template processing provided by this embodiment selects among a plurality of video templates at least one video template matching with the at least one material content and determine the video template selected by the second user as the target video template. Accordingly, while the matching degree between the material content and the video template is improved, the target video template for generating the target video conforms more to the individualized needs of the second user and the user experience is further enhanced.

Moreover, based on one of the above embodiments, the step 601 includes:
determining material parameters corresponding to the at least one material content, wherein the material parameters include one or more of material type, material duration, material amount and material feature;
determining in the plurality of video templates at least one video template matching with the material parameters based on the material parameters.

In this embodiment, in order to more accurately obtain the target video template matching with the at least one material content, material parameters corresponding to the at least one material content may be determined, wherein the material parameters include one or more of material type, material duration, material amount and material feature. The material type, material duration and material amount may be attribute information associated with the material content selected by the second user. The material feature may be obtained through the feature extraction on the at least one material content, wherein the operation of extracting the material feature may be implemented by any algorithm that can perform image feature extraction. The present disclosure is not restricted in this regard.

Furthermore, for each video template, when the first user generates the video template, slots in the video template may be configured to determine material type, material duration and material feature corresponding to each slot. In addition, each video template corresponds to at least one slot and the slot amount may be determined as material quantity. Therefore, after the material parameters corresponding to the at least one material content are determined, the at least one video template may be determined according to the slot information of a plurality of video templates corresponding to the material parameters.

Based on any of the above embodiments, the determining material parameters corresponding to the at least one material content includes:
for image material contents, performing a feature extraction operation on the image material content through a preset feature extraction algorithm to obtain the material feature;
for video material contents, performing a frame extraction operation on the video material contents according to a preset frame extraction condition, to obtain at least one video frame;
performing a feature extraction operation on the video frame through a preset feature extraction algorithm to obtain the material feature.

In this embodiment, the material content includes image material content and video material content. To accurately extract the material feature of the material content, different methods may be adopted for the feature extraction on various types of material contents.

Alternatively, in case that the material content is image material content, a feature extraction operation may be directly performed on the image material content through a preset feature extraction algorithm to obtain the material feature. When a plurality of image material contents is included, the feature extraction operation may be performed on each image material content separately. The material features corresponding to a plurality of image material contents may be spliced to obtain the material feature.

In case that the material content is the video material content, the video material content is made of a plurality of video frames. In order to accurately perform the feature extraction operation, a frame extraction operation may be performed on the video material contents according to a preset frame extraction condition, to obtain at least one video frame, wherein the preset frame extraction condition may be extracting one video frame every N frames, or extracting one video frame every N seconds. The present disclosure is not restricted in this regard. Or, the user also may set the frame extraction condition in view of the actual requirements.

For each video frame extracted, the feature extraction operation may be performed on the video frame throug the preset feature extraction algorithm, to obtain the material feature. In case of a plurality of video frames, the material features corresponding to the plurality of video frames may be spliced to gain the material feature.

Wherein, the operation of extracting the material feature may be implemented by any algorithm that can perform image feature extraction. The present disclosure is not restricted in this regard.

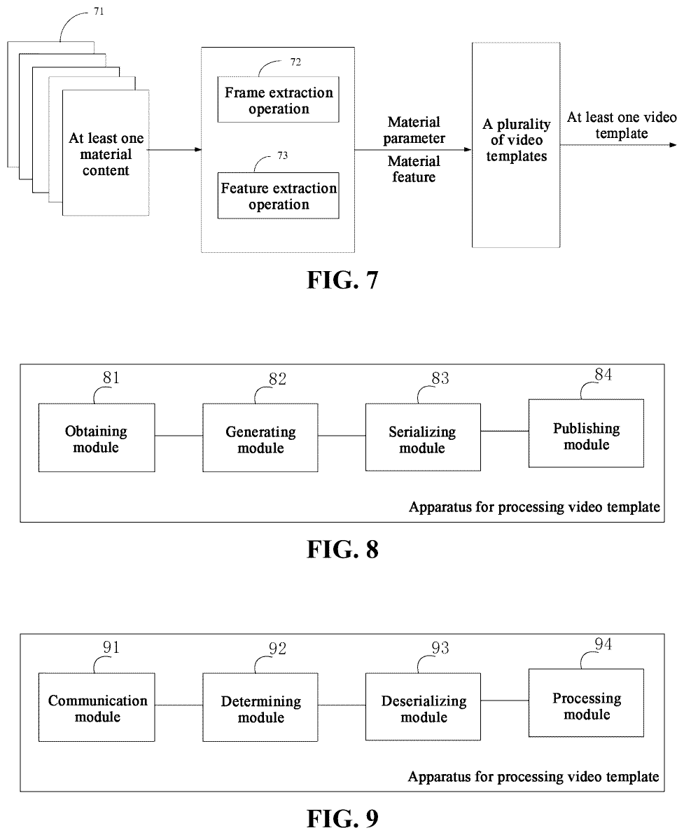

FIG. 7 illustrates a schematic diagram of another application scenario provided by an embodiment of the present disclosure. As shown in FIG. 7, after the at least one material content 71 determined by the second user is obtained, a frame extraction operation 72 and a feature extraction operation 73 may be performed on the at least one material content 71, to obtain the material feature corresponding to the at least one material content. Based on the material feature and parameters associated with the at least one material content, such as material type, material duration, and material amount etc., at least one video template matching with the material parameters is determined in a plurality of video templates.

The method for video template processing provided by this embodiment obtains the material feature and the material parameters associated with the material content, so as to accurately determine among a plurality of preset video templates at least one material content matching with the material content. Moreover, the matching degree between the material content and the target video template is enhanced, to generate the target video of better quality.

FIG. 8 illustrates a structural diagram of the apparatus for video template processing provided by an embodiment of the present disclosure. As shown in FIG. 8, the apparatus comprises: an obtaining module 81 for obtaining at least one editing element for generating a video template, wherein the editing element includes slot information and audio content corresponding to a timeline associated with the video template, and at least one effect element; and the slot information includes a time range and material parameters corresponding to each preset slot, the material parameters comprising at least one material type and a material feature; a generation module 82 for generating, based on the editing element, a video editing model through a preset template editing protocol, wherein the template editing protocol includes a plurality of material types and declaration information corresponding to effect elements; a serializing module 83 for serializing the video editing model based on the template editing protocol to obtain a serialized target video template; and a publishing module 84 for publishing the target video template in a preset application.

Furthermore, based on any of the above embodiments, the generation module is provided for: editing the editing element based on a preset first software development kit, to generate a data packet to be edited;
determining, based on the template editing protocol, description information corresponding to the data packet to be edited through a preset second software development kit, and obtaining resource contents associated with the data packet to be edited, wherein the resource contents include one or more of effect resources, music resources, material resources and resource addresses;
generating the video editing model based on the data packet to be edited, description information and the resource content.

Based on any of the above embodiments, the first software development kit includes a video development kit and an effect development kit. The generation module is provided for: editing the at least one effect element based on the effect development kit, to generate an effect data packet; editing, based on the video development kit, slot information and audio content corresponding to a timeline associated with the video template, to generate a video data packet; generating the data packet to be edited according to the effect data packet and the video data packet.

Based on any of the above embodiments, the generation module is provided for: for each resource content in the data packet to be edited, obtaining the resource content from a storage path associated with the resource content; if the storage path does not include the resource content, determining a resource address associated with the resource content.

Based on any of the above embodiments, the obtaining module is provided for: obtaining at least one editing element determined by a first user in a target application. The apparatus further comprises: an editing module configured to edit the editing element based on a preset first software development kit, to generate a data packet to be edited; a rendering module configured to render the data packet to be edited to obtain a rendering effect; and a presentation module configured to present the rendering effect in the target application, to allow the first user to adjust the at least one editing element based on the rendering effect.

FIG. 9 illustrates a structural diagram of the apparatus for video template processing provided by an embodiment of the present disclosure. As shown in FIG. 9, the apparatus comprises: a communication module 91 for obtaining at least one material content determined by a second user, the material content including a target video and/or an image content; a determination module 92 for determining, among a preset plurality of video templates a target video template matching with the at least one material content, the target video template being generated based on the method for video template processing according to any of the above embodiments; a deserializing module 93 for deserializing the target video template through a preset template editing protocol to obtain a video editing model matching with the target video template; and a processing module 94 for performing a video generating operation based on the video editing model and the at least one material content.

Based on any of the above embodiments, the determination module is provided for: determining, among a preset plurality of video templates, at least one video template matching with the at least one material content; recommending the at least one video template to the second user and determining a video template selected by the second user as the target video template.

Based on any of the above embodiments, the determination module is provided for: determining material parameters corresponding to the at least one material content, wherein the material parameters include one or more of material type, material duration, material amount and material feature; determining in the plurality of video templates at least one video template matching with the material parameters based on the material parameters.

Based on any of the above embodiments, the determination module is provided for: for image material contents, performing a feature extraction operation on the image material content through a preset feature extraction algorithm to obtain the material feature; for video material contents, performing a frame extraction operation on the video material contents according to a preset frame extraction condition, to obtain at least one video frame; performing a feature extraction operation on the video frame through a preset feature extraction algorithm to obtain the material feature.

Moreover, based on any of the above embodiments, the processing module is provided for: for each material content, determining a target slot matching with the material content in the video editing model; adding the material content to the target slot to generate a target video.

The device provided by this embodiment may be used to execute the technical solution of the above method embodiments. The implementation principles and the technical effects are similar and will not be repeated here.

To implement the above embodiments, embodiments of the present disclosure also provide a computer-readable storage medium stored with computer-executable instructions therein, wherein the computer-executable instructions, when executed by a processor, implement the method for video template processing according to any of the above embodiments.

To implement the above embodiments, embodiments of the present disclosure also provide a computer program product comprising computer programs, wherein the computer programs, when executed by a processor, fulfill the method for content rendering according to any of the above embodiments.

To implement the above embodiments, embodiments of the present disclosure also provide an electronic device, comprising: a processor and a memory;
wherein the memory is stored with computer-executable instructions;
the processor executes computer-executable instructions stored in the memory, such that the processor performs the method for content rendering according to any of the above embodiments.

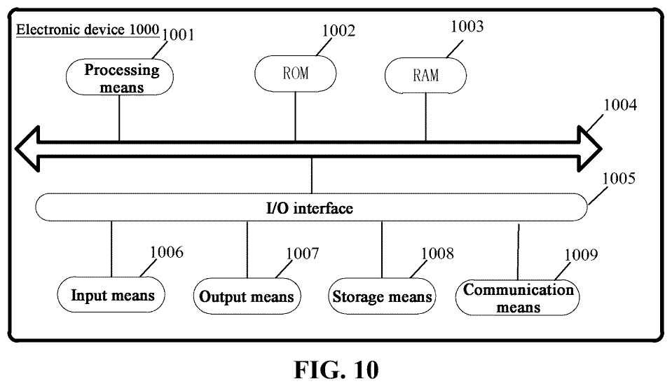

FIG. 10 illustrates a structural diagram of an electronic device provided by embodiments of the present disclosure. The electronic device 1000 may be a terminal device or a server, wherein the terminal device may include, but not limited to, mobile terminals, such as mobile phones, notebooks, digital broadcast receivers, PDA (Personal Digital Assistant), PAD (Portable Android Device), PMP (Portable Multimedia Player) and vehicle terminals (such as car navigation terminal) and fixed terminals, e.g., digital TVs and desktop computers etc. The electronic device shown in FIG. 10 is just an example and will not put any restrictions on the functions and application ranges of the embodiments of the present disclosure.

According to FIG. 10, the electronic device 1000 may include a processing means (e.g., central processor, graphic processor and the like) 1001, which can execute various suitable actions and processing based on the programs stored in the read-only memory (ROM) 1002 or programs loaded in the random-access memory (RAM) 1003 from a storage means1008. The RAM 1003 can also store all kinds of programs and data required by the operations of the electronic device 1000. Processing means 1001, ROM 1002 and RAM 1003 are connected to each other via a bus 1004. The input/output (I/O) interface 1005 is also connected to the bus 1004.

Usually, input means1006 (including touch screen, touchpad, keyboard, mouse, camera, microphone, accelerometer, gyroscope and like) and output means1007 (including liquid crystal display (LCD), speaker and vibrator etc.), storage means1008 (including tape and hard disk etc.) and communication means1009 may be connected to the I/O interface 1005. The communication means1009 may allow the electronic device 1000 to exchange data with other devices through wired or wireless communications. Although FIG. 10 illustrates the electronic device 1000 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including computer programs carried on a computer readable medium, wherein the computer programs include program codes for executing the method demonstrated by the flowchart. In these embodiments, the computer programs may be loaded and installed from networks via the communication means1009, or installed from the storage means1008, or installed from the ROM 1002. The computer programs, when executed by the processing means 1001, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein.

Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The above computer readable medium may be included in the aforementioned electronic device or stand-alone without fitting into the electronic device.

The above computer readable medium bears one or more programs. When the above one or more programs are executed by the electronic device, the electronic device is enabled to execute the method illustrated by the above embodiments.

Computer program instructions for executing operations of the present disclosure are written in one or more programming languages or combinations thereof. The above programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, the first obtaining unit also may be described as “a unit for obtaining at least two Internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In a first aspect, according to one or more embodiments of the present disclosure, there is provided a method for video template processing, comprising:
obtaining at least one editing element for generating a video template, wherein the editing element includes slot information and audio content corresponding to a timeline associated with the video template, and at least one effect element; and the slot information includes a time range and material parameters corresponding to each preset slot, the material parameters comprising at least one material type and a material feature;
generating, based on the editing element, a video editing model through a preset template editing protocol, wherein the template editing protocol includes a plurality of material types and declaration information corresponding to effect elements;
serializing the video editing model based on the template editing protocol to obtain a serialized target video template;
publishing the target video template in a preset application.

According to one or more embodiments of the present disclosure, the generating, based on the editing element, a video editing model through a preset template editing protocol includes:
editing the editing element based on a preset first software development kit, to generate a data packet to be edited;
determining, based on the template editing protocol, description information corresponding to the data packet to be edited through a preset second software development kit, and obtaining resource contents associated with the data packet to be edited, wherein the resource contents include one or more of effect resources, music resources, material resources and resource addresses;

generating the video editing model based on the data packet to be edited, description information and the resource content.

According to one or more embodiments of the present disclosure, the first software development kit includes a video development kit and an effect development kit;
the editing the editing element based on a preset first software development kit, to generate a data packet to be edited includes:
editing the at least one effect element based on the effect development kit, to generate an effect data packet;
editing, based on the video development kit, slot information and audio content corresponding to a timeline associated with the video template, to generate a video data packet;
generating the data packet to be edited according to the effect data packet and the video data packet.

According to one or more embodiments of the present disclosure, the obtaining resource contents associated with the data packet to be edited includes:
for each resource content in the data packet to be edited, obtaining the resource content from a storage path associated with the resource content;
if the storage path does not include the resource content, determining a resource address associated with the resource content.

According to one or more embodiments of the present disclosure, the obtaining at least one editing element for generating a video template includes:
obtaining at least one editing element determined by a first user in a target application;
the method further comprises:
editing the editing element based on a preset first software development kit, to generate a data packet to be edited;
rendering the data packet to be edited to obtain a rendering effect;
presenting the rendering effect in the target application, to allow the first user to adjust the at least one editing element based on the rendering effect.

In a second aspect, according to one or more embodiments of the present disclosure, there is provided a method for video template processing, comprising:
obtaining at least one material content determined by a second user, the material content including a target video and/or an image content;
determining, among a preset plurality of video templates, a target video template matching with the at least one material content, the target video template being generated based on the method for video template processing according to any of the above embodiments;
deserializing the target video template through a preset template editing protocol to obtain a video editing model matching with the target video template;
performing a video generating operation based on the video editing model and the at least one material content.

According to one or more embodiments of the present disclosure, the determining, among a preset plurality of video templates, a target video template matching with the at least one material content includes:
determining, among a preset plurality of video templates, at least one video template matching with the at least one material content;
recommending the at least one video template to the second user and determining a video template selected by the second user as the target video template.

According to one or more embodiments of the present disclosure, the determining, among a preset plurality of video templates, at least one video template matching with the at least one material content includes:
determining material parameters corresponding to the at least one material content, wherein the material parameters include one or more of material type, material duration, material amount and material feature;
determining in the plurality of video templates at least one video template matching with the material parameters based on the material parameters.

According to one or more embodiments of the present disclosure, the determining material parameters corresponding to the at least one material content includes:
for image material contents, performing a feature extraction operation on the image material content through a preset feature extraction algorithm to obtain the material feature;
for video material contents, performing a frame extraction operation on the video material contents according to a preset frame extraction condition, to obtain at least one video frame;
performing a feature extraction operation on the video frame through a preset feature extraction algorithm to obtain the material feature.

According to one or more embodiments of the present disclosure, the performing a video generating operation based on the video editing model and the at least one material content includes:
for each material content, determining a target slot matching with the material content in the video editing model;
adding the material content to the target slot to generate a target video.

In a third aspect, according to one or more embodiments of the present disclosure, there is provided an apparatus for video template processing, comprising:
an obtaining module configured to obtain at least one editing element for generating a video template, wherein the editing element includes slot information and audio content corresponding to a timeline associated with the video template, and at least one effect element; and the slot information includes a time range and material parameters corresponding to each preset slot, the material parameters comprising at least one material type and a material feature;
a generation module configured to generate, based on the editing element, a video editing model through a preset template editing protocol, wherein the template editing protocol includes a plurality of material types and declaration information corresponding to effect elements;
a serializing module configured to serialize the video editing model based on the template editing protocol to obtain a serialized target video template;
a publishing module configured to publish the target video template in a preset application.

According to one or more embodiments of the present disclosure,
the generation module is provided for:
editing the editing element based on a preset first software development kit, to generate a data packet to be edited;
determining, based on the template editing protocol, description information corresponding to the data packet to be edited through a preset second software development kit, and obtaining resource contents associated with the data packet to be edited, wherein the resource contents include one or more of effect resources, music resources, material resources and resource addresses;
generating the video editing model based on the data packet to be edited, description information and the resource content.

According to one or more embodiments of the present disclosure, the first software development kit includes a video development kit and an effect development kit.

The generation module is provided for:
editing the at least one effect element based on the effect development kit, to generate an effect data packet;
editing, based on the video development kit, slot information and audio content corresponding to a timeline associated with the video template, to generate a video data packet;
generating the data packet to be edited according to the effect data packet and the video data packet.

According to one or more embodiments of the present disclosure, the generation module is provided for:
for each resource content in the data packet to be edited, obtaining the resource content from a storage path associated with the resource content;
if the storage path does not include the resource content, determining a resource address associated with the resource content.

According to one or more embodiments of the present disclosure, the obtaining module is provided for:
obtaining at least one editing element determined by a first user in a target application.

The apparatus further comprises:
an editing module configured to edit the editing element based on a preset first software development kit, to generate a data packet to be edited;
a rendering module configured to render the data packet to be edited to obtain a rendering effect; and
a presentation module configured to present the rendering effect in the target application, to allow the first user to adjust the at least one editing element based on the rendering effect.

In a fourth aspect, according to one or more embodiments of the present disclosure, there is provided an apparatus for video template processing, comprising:
a communication module configured to obtain at least one material content determined by a second user, the material content including a target video and/or an image content;
a determination module configured to determine, among a preset plurality of video templates, a target video template matching with the at least one material content, the target video template being generated based on the method for video template processing according to any of the above embodiments;
a deserializing module configured to deserialize the target video template through a preset template editing protocol to obtain a video editing model matching with the target video template;
a processing module configured to perform a video generating operation based on the video editing model and the at least one material content.

According to one or more embodiments of the present disclosure, the determination module is provided for:
determining, among a preset plurality of video templates, at least one video template matching with the at least one material content;
recommending the at least one video template to the second user and determining a video template selected by the second user as the target video template.

According to one or more embodiments of the present disclosure, the determination module is provided for:
determining material parameters corresponding to the at least one material content, wherein the material parameters include one or more of material type, material duration, material amount and material feature;
determining in the plurality of video templates at least one video template matching with the material parameters based on the material parameters.

According to one or more embodiments of the present disclosure, the determination module is provided for:
for image material contents, performing a feature extraction operation on the image material content through a preset feature extraction algorithm to obtain the material feature;
for video material contents, performing a frame extraction operation on the video material contents according to a preset frame extraction condition, to obtain at least one video frame;
performing a feature extraction operation on the video frame through a preset feature extraction algorithm to obtain the material feature.

According to one or more embodiments of the present disclosure, the processing module is provided for:
for each material content, determining a target slot matching with the material content in the video editing model;
adding the material content to the target slot to generate a target video.

In a fifth aspect, according to one or more embodiments of the present disclosure, there is provided an electronic device, comprising: a processor and a memory;
wherein the memory is stored with computer-executable instructions;
the processor executes computer-executable instructions stored in the memory, such that the processor performs the method for video template processing according to the above first aspect and various possible designs of the first aspect.

In a sixth aspect, according to one or more embodiments of the present disclosure, there is provided a computer-readable storage medium stored with computer-executable instructions therein, wherein the computer-executable instructions, when executed by a processor, implement the method for video template processing according to the above first aspect and various possible designs of the first aspect.

In a seventh aspect, according to one or more embodiments of the present disclosure, there is provided a computer program product comprising computer programs, wherein the computer programs, when executed by a processor, fulfill the method for video template processing according to the above first aspect and various possible designs of the first aspect.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. A method for video template processing, comprising:
obtaining at least one editing element for generating a video template, wherein the editing element comprises slot information and audio content corresponding to a timeline associated with the video template, and at least one effect element; the slot information comprises a time range and material parameters corresponding to each preset slot, the material parameters comprise at least one material type and a material feature;
generating, based on the editing element, a video editing model through a preset template editing protocol, wherein the template editing protocol comprises a plurality of material types and declaration information corresponding to effect elements;
serializing the video editing model based on the template editing protocol to obtain a serialized target video template; and
publishing the target video template in a preset application.

2. The method of claim 1, wherein generating the video editing model, based on the editing element, through the preset template editing protocol comprises:
editing the editing element based on a preset first software development kit, to generate a data packet to be edited;
determining, based on the template editing protocol, description information corresponding to the data packet to be edited through a preset second software development kit, and obtaining resource contents associated with the data packet to be edited, wherein the resource contents comprise one or more of effect resources, music resources, material resources and resource addresses; and
generating the video editing model based on the data packet to be edited, the description information and the resource content.

3. The method of claim 2, wherein the first software development kit comprises a video development kit and an effect development kit;
wherein editing the editing element based on the preset first software development kit, to generate the data packet to be edited comprises:
editing the at least one effect element based on the effect development kit, to generate an effect data packet;
editing, based on the video development kit, the slot information and the audio content corresponding to the timeline associated with the video template, to generate a video data packet; and
generating the data packet to be edited according to the effect data packet and the video data packet.

4. The method of claim 2, wherein obtaining the resource contents associated with the data packet to be edited comprises:
for each resource content in the data packet to be edited, obtaining the resource content from a storage path associated with the resource content; and
in response to the storage path not comprising the resource content, determining a resource address associated with the resource content.

5. The method of claim 1, wherein obtaining the at least one editing element for generating the video template comprises:
obtaining at least one editing element determined by a first user in a target application;
wherein the method further comprises:
editing the editing element based on a preset first software development kit, to generate a data packet to be edited;
rendering the data packet to be edited to obtain a rendering effect; and
presenting the rendering effect in the target application, to allow the first user to adjust the at least one editing element based on the rendering effect.

6. A method for video template processing, comprising:
obtaining at least one material content determined by a second user, the material content comprising a target video and/or an image content;
determining, among a preset plurality of video templates, a target video template matching with the at least one material content, the target video template being generated based on the method for video template processing of claim 1;
deserializing the target video template through a preset template editing protocol to obtain a video editing model matching with the target video template; and
performing a video generating operation based on the video editing model and the at least one material content.

7. The method of claim 6, wherein determining, among the preset plurality of video templates, the target video template matching with the at least one material content comprises:
determining, among the preset plurality of video templates, at least one video template matching with the at least one material content; and
recommending the at least one video template to the second user and determining a video template selected by the second user as the target video template.

8. The method of claim 7, wherein determining, among the preset plurality of video templates, the at least one video template matching with the at least one material content comprises:
determining material parameters corresponding to the at least one material content, wherein the material parameters comprise one or more of material type, material duration, material amount and material feature; and
determining, among the plurality of video templates, at least one video template matching with the material parameters based on the material parameters.

9. The method of claim 8, wherein determining the material parameters corresponding to the at least one material content comprises:
for image material contents, performing a feature extraction operation on the image material content through a preset feature extraction algorithm to obtain the material feature;
for video material contents, performing a frame extraction operation on the video material contents according to a preset frame extraction condition, to obtain at least one video frame; and
performing a feature extraction operation on the video frame through a preset feature extraction algorithm to obtain the material feature.

10. The method of claim 6, wherein performing the video generating operation based on the video editing model and the at least one material content comprises:
for each material content, determining a target slot matching with the material content in the video editing model; and
adding the material content to the target slot to generate a target video.

11. An electronic device, comprising: a processor and a memory storing computer-executable instructions,
wherein the computer-executable instructions, when executed by the processor, cause the processor to perform:
obtain at least one editing element for generating a video template, wherein the editing element comprises slot information and audio content corresponding to a timeline associated with the video template, and at least one effect element; the slot information comprises a time range and material parameters corresponding to each preset slot, the material parameters comprise at least one material type and a material feature;
generate, based on the editing element, a video editing model through a preset template editing protocol, wherein the template editing protocol comprises a plurality of material types and declaration information corresponding to effect elements;
serialize the video editing model based on the template editing protocol to obtain a serialized target video template; and
publish the target video template in a preset application.

12. The electronic device of claim 11, wherein the computer-executable instructions that cause the processor to generate the video editing model, based on the editing element, through the preset template editing protocol comprise instructions to cause the processor to:
edit the editing element based on a preset first software development kit, to generate a data packet to be edited;
determine, based on the template editing protocol, description information corresponding to the data packet to be edited through a preset second software development kit, and obtain resource contents associated with the data packet to be edited, wherein the resource contents comprise one or more of effect resources, music resources, material resources and resource addresses; and
generate the video editing model based on the data packet to be edited, the description information and the resource content.

13. The electronic device of claim 12, wherein the first software development kit comprises a video development kit and an effect development kit;
wherein the instructions that cause the processor to edit the editing element based on the preset first software development kit, to generate the data packet to be edited comprise instructions to cause the processor to:
edit the at least one effect element based on the effect development kit, to generate an effect data packet;
edit, based on the video development kit, the slot information and the audio content corresponding to the timeline associated with the video template, to generate a video data packet; and
generate the data packet to be edited according to the effect data packet and the video data packet.

14. The electronic device of claim 12, wherein the instructions that cause the processor to obtain the resource contents associated with the data packet to be edited comprise instructions to cause the processor to:
for each resource content in the data packet to be edited, obtain the resource content from a storage path associated with the resource content; and
in response to the storage path not comprising the resource content, determine a resource address associated with the resource content.

15. The electronic device of claim 11, wherein the computer-executable instructions that cause the processor to obtain the at least one editing element for generating the video template comprise instructions to cause the processor to:
obtain at least one editing element determined by a first user in a target application;
wherein the processor further caused to:
edit the editing element based on a preset first software development kit, to generate a data packet to be edited;
render the data packet to be edited to obtain a rendering effect; and
present the rendering effect in the target application, to allow the first user to adjust the at least one editing element based on the rendering effect.

16. The electronic device of claim 11, wherein the processor further caused to:
obtain at least one material content determined by a second user, the material content comprising a target video and/or an image content;
determine, among a preset plurality of video templates, the target video template matching with the at least one material content;
deserialize the target video template through a preset template editing protocol to obtain a video editing model matching with the target video template; and
perform a video generating operation based on the video editing model and the at least one material content.

17. The electronic device of claim 16, wherein the computer-executable instructions that cause the processor to determine, among the preset plurality of video templates, the target video template matching with the at least one material content comprise instructions to cause the processor to:
determine, among the preset plurality of video templates, at least one video template matching with the at least one material content; and
recommend the at least one video template to the second user and determining a video template selected by the second user as the target video template.

18. The electronic device of claim 17, wherein the instructions that cause the processor to determine, among the preset plurality of video templates, the at least one video template matching with the at least one material content comprise instructions to cause the processor to:
determine material parameters corresponding to the at least one material content, wherein the material parameters comprise one or more of material type, material duration, material amount and material feature; and
determine, among the plurality of video templates, at least one video template matching with the material parameters based on the material parameters.

19. The electronic device of claim 18, wherein the instructions that cause the processor to determine the material parameters corresponding to the at least one material content comprise instructions to cause the processor to:
for image material contents, perform a feature extraction operation on the image material content through a preset feature extraction algorithm to obtain the material feature;
for video material contents, perform a frame extraction operation on the video material contents according to a preset frame extraction condition, to obtain at least one video frame; and
perform a feature extraction operation on the video frame through a preset feature extraction algorithm to obtain the material feature.

20. The electronic device of claim 16, wherein the computer-executable instructions that cause the processor to perform the video generating operation based on the video editing model and the at least one material content comprise instructions to cause the processor to:
for each material content, determine a target slot matching with the material content in the video editing model; and
add the material content to the target slot to generate a target video.
